(19) United States
(12) Patent Application Publication
(10) Pub. No.: US 2007/0058502 A1
(43) Pub. Date: Mar. 15, 2007

(54) SERVO SYSTEM AND RELATED METHOD OF ADJUSTING THE MAGNITUDE OF DETECTING SIGNALS OUTPUTTED FROM A PICK-UP HEAD BEFORE UTILIZING THE DETECTING SIGNALS TO GENERATE SERVO SIGNALS

(76) Inventors: Chi-Pei Huang, Miao- Li Hsien (TW); Chao-Ming Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/162,488

(22) Filed: Sep. 12, 2005

(51) Int. Cl. G11B 7/00

(52) U.S. Cl. 369/44.35

(57) ABSTRACT

A servo system of an optical storage device and related method for generating a servo signal. The servo system includes a pick-up head for detecting signals reflected from an optical disc to generate a plurality of detecting signals; a gain stage coupled to the pick-up head for determining a gain value according to an output of the pick-up head and for adjusting the magnitude of the detecting signals according to the gain value; and a servo signal generator coupled to the gain stage for generating the servo signal according to the adjusted detecting signals outputted from the gain stage.

### BACKGROUND

The present invention relates to a servo system of an optical disc drive, and more particularly, to a servo system of an optical disc drive capable of adjusting the magnitude of detecting signals outputted from a pick-up head according to a gain value and then utilizing the adjusted detecting signals to generate servo signals.

Optical storage medium, such as DVD, is currently a very popular storage medium. FIG. 1 shows a block diagram of a first related art optical disc drive 100. The optical disc drive 100 has a pick-up head 110 utilized to access an optical disc 101 for reading data and recording data. The pick-up head 110 includes a laser diode 112 utilized for emitting a laser beam with a specific laser power onto a track of the optical disc 101 and a photo detector 114 utilized for detecting the laser beam reflected from the optical disc 101 (e.g., reflected main-beam signals and reflected side-beam signals) to generate a plurality of detecting signals. As shown in FIG. 1, the photo detector 114 has four sensing areas for outputting detecting main beam signals A, B, C, and D respectively. And another four sensing areas for outputting detecting side beam signals E, F, G, and H. The servo signal generator 140 functions as a signal synthesizer for synthesizing the detecting signals A˜H to generate servo signals. Servo signals include signals such as: a tracking error signal TE, which represents the position offset component of a laser spot with respect to the target track on the optical disc 101, and a focusing error signal FE, which represents the focus offset component of the laser spot with respect to the target layer of the optical disc 101.

A signal adjuster 145 is utilized to normalize the tracking error signal TE and the focusing error signal FE and generate a first adjusted tracking error signal TE′ and a first adjusted focusing error signal FE′. A gain modifier 150 applies a specific gain to increase or decrease the first adjusted tracking error signal TE′ and the first adjusted focusing error signal FE′ and outputs the second adjusted tracking error signal TE″ and the second adjusted focusing error signal FE″. Then, based on the second adjusted tracking error signal TE″ and the second adjusted focusing error signal FE″, the servo controller 160 sends a tracking servo output signal TRO and a focus servo output signal FOO to the actuator driver 170. The actuator driver 170 drives an actuator 180, based on the control signal from the servo controller 160, to move the pick-up head 110 horizontally and vertically so as to minimize both the tracking error and the focusing error.

Generally, the laser power required for recording information on the optical disc 101 is much higher than the laser power required for reproducing information from the optical disc 101. Therefore, under write mode, the servo signals TE, FE are certain to be affected by the writing pulses with high laser power. In an effort to minimize the impact caused by the write power, the signal adjuster 145 divides the servo signals by a sum of the detecting signals A, B, C, and D to normalize the servo signals. In other words, the adjusted tracking error signal TE′ and the adjusted focusing error signal FE′ can be expressed as follows:
TE′=TE/(A+B+C+D)
FE′=FE/(A+B+C+D)

Utilizing the normalization, the stability of the servo control mechanism can be improved, however, if the write power is too large, then the normalizing servo signals TE, FE may be distorted because the signal intensity detected by the photo detector 114 of the pick-up head 110 is higher than the upper limit of the normalization range of the signal adjuster 145. That is, the normalization performed on the tracking error signal TE and the focusing error signal FE is unable to recover the correct servo signals. Ultimately, the incorrect TE and FE values will propagate causing the servo control mechanism to fail under this situation. Consider also that the servo signals are produced based on a main beam push-pull signal and a side beam push-pull signal. The variation of the signal intensity reflected from the side beam during recoding is different and much less than the variation of the signal intensity reflected from the main beam. Because the reflected main beam and the reflected side beam are affected differently, the servo signals can hardly be normalized by simply utilizing the sum of the detecting signals A, B, C, and D.

FIG. 2 is a block diagram of a second related art optical disc drive 200. The optical disc drive 200 shown in FIG. 2 is similar to the optical disc drive 100 shown in FIG. 1. The key difference is that the optical disc drive 200 adopts a sample/hold circuit 210 to minimize the impact caused by write pulses with high laser power. Please refer to FIG. 3 in conjunction with FIG. 2. FIG. 3 depicts the different power levels of the detecting signals A, B, C, and D during the recording process. The “A level” corresponds to the peak power generated from the photo detector 114. The “B level” corresponds to the write power generated from the photo detector 114. The “C level” corresponds to the read power generated from the photo detector 114. That is, the power of light reflected from the optical disc 101 differs due to different laser power irradiated onto the optical disc 101 during data recording. Thus, a significant change of reflected light affects the gain of the entire servo system of the optical disc drive 100. This means that the servo gain is more susceptible to fluctuation. The optical disc drive 200 utilizes a sample/hold scheme to sample the detecting signals A, B, C, and D during a “C level” period and hold the sampled value during the “A level” period and “B level” period. Because the “C level” corresponds to the read power, the servo signals (i.e., the tracking error signal TE and the focusing error signal FE) generated during the recording process are not boosted due to the high write power. Thus the stability of the servo control mechanism is improved. However, considering the hardware restriction on the sample/hold circuit 210, the sampling timing is limited when the data are recorded at high speed. In conclusion, the sample/hold scheme is not applicable to the high-speed recording process.

### SUMMARY

It is one of the objectives of the present invention to provide a servo system and related method capable of adjusting the magnitude of detecting signals outputted from a pick-up head according to a gain value and then synthesize the adjusted detecting signals to generate servo signals, to solve the above-mentioned problems.

According to an aspect of the present invention, a servo system of an optical storage device is disclosed. The servo system comprises: a pick-up head for detecting signals reflected from an optical disc to generate a plurality of detecting signals; a gain stage coupled to the pick-up head for determining a gain value according to an output of the pick-up head and for adjusting the magnitude of the detecting signals according to the gain value; and a servo signal generator coupled to the gain stage for generating the servo signal according to the adjusted detecting signals outputted from the gain stage.

According to another aspect of the present invention, a method for generating a servo signal of an optical storage device is disclosed. The method comprises: detecting signals reflected from an optical disc to generate a plurality of detecting signals by a pick-up head; determining a gain value according to an output of the pick-up head; adjusting the magnitude of the detecting signals according to the gain value; and generating the servo signal according to the detecting signals adjusted by the gain value.

The servo system of the present invention has improved stability. Prior to generating the servo signals (i.e., the tracking error signal TE and a focusing error signal FE), the servo system utilizes a gain stage to properly adjust the magnitude of detecting signals generated from a photo detector of a pick-up head, thereby minimizing the influence of the write power. Further, the servo system of the present invention respectively adjusts the magnitude of the reflected main beam signals and reflected side beam signals, and is capable of preventing the servo signals from fluctuating heavily. The servo system of the present invention is capable of immediately updating the gain value in response to the write power adjustment during the data recording process. As compared with the related art servo system that utilizes the sample/hold scheme, the servo system of the present invention is applicable to high-speed data recording.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a first related art optical disc drive.

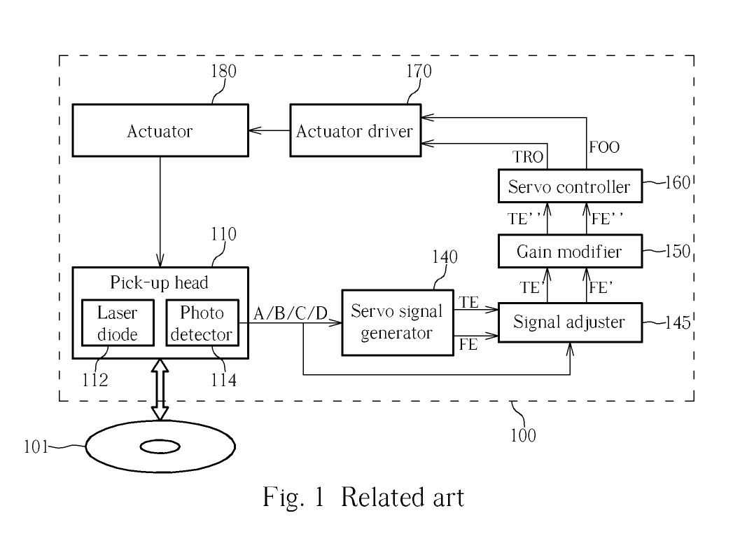

FIG. 2 is a block diagram of a second related art optical disc drive.

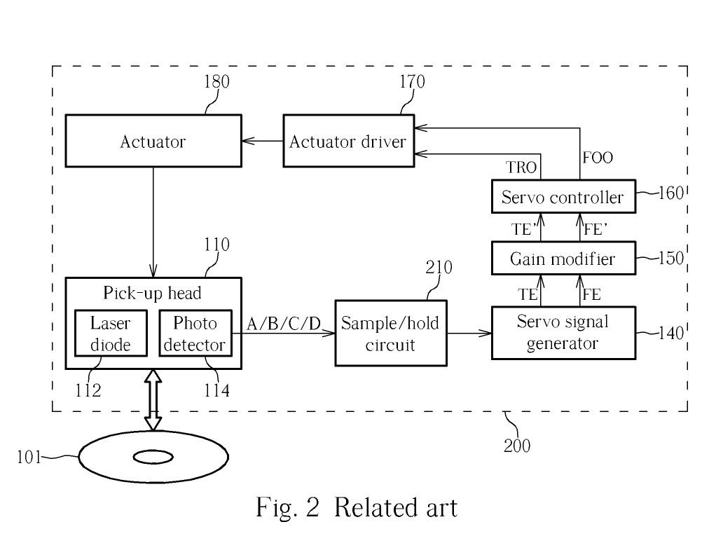

FIG. 3 is a diagram illustrating different power levels of detecting signals during the recording process.

FIG. 4 is a block diagram of a servo system in an optical disc drive according to a first embodiment of the present invention.

FIG. 5 is a flowchart illustrating the detailed operation of tuning a gain value set to a gain-adjusting module shown in FIG. 4.

FIG. 6 is a block diagram of a servo system in an optical disc drive according to a second embodiment of the present invention.

### DETAILED DESCRIPTION

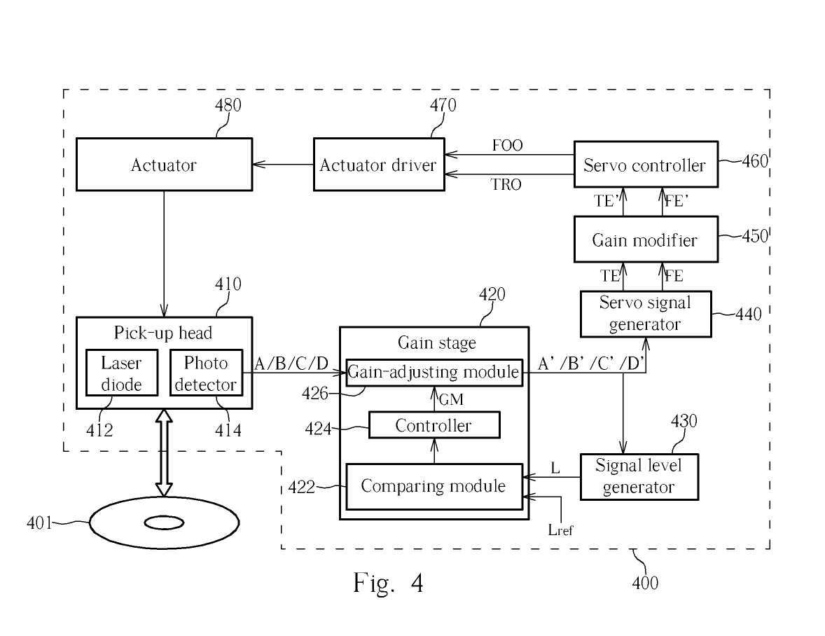

Please refer to FIG. 4. FIG. 4 shows a block diagram of a servo system 400 in an optical disc drive (e.g., a DVD drive) according to a first embodiment of the present invention. The servo system 400 is utilized to control the position of the pick-up head 410 when the pick-up head 410 is accessing the optical disc 401. In this embodiment, the servo system 400 is stabilized because of the gain stage 420. Please note that the operation of the gain stage 420 is detailed later. The pick-up head 410 includes a laser diode 412. The laser diode 412 is utilized for emitting a laser beam with a specific laser power onto a track of the optical disc 401 and a photo detector 414 utilized for detecting laser beam reflected from the optical disc 401 (e.g., reflected main-beam signals and reflected side-beam signals) to generate a plurality of detecting signals. As is well known to those skilled in this art, the photo detector 414 has four sensing areas for outputting four detecting signals A, B, C, and D to detect the reflected main beam signal, and another four sensing areas for outputting four detecting signals E, F, G, H to detect the reflect side beam signal.

The gain stage 420 is utilized for determining a gain value GM according to a signal level L outputted from a signal level generator 430 and for adjusting the magnitude of the detecting signals A, B, C, and D according to the selected gain value GM. A servo signal generator 440 serves as a signal synthesizer for generating servo signals (i.e., a tracking error signal TE and a focusing error signal FE) according to the adjusted detecting signals A′, B′, C′, and D′ outputted from the gain stage 420. Then, a gain modifier 450 applies a specific gain to adjust the tracking error signal TE and the focusing error signal FE and outputs the adjusted tracking error signal TE′ and the adjusted focusing error signal FE′.

Next, the servo controller 460 generates a tracking servo output signal TRO and a focus servo output signal FOO according to the incoming adjusted tracking error signal TE′ and the adjusted focusing error signal FE′ from the gain modifier 450. After receiving the tracking servo output signal TRO and the focus servo output signal FOO, the actuator driver 470 drives an actuator 480 to move the pick-up head 410 horizontally and vertically to minimize the tracking error and the focusing error.

As shown in FIG. 4, the gain stage 420 includes a comparing module 422, a controller 424 and a gain-adjusting module 426. The comparing module 422 compares the signal level L with a reference target level L_{ref} to determine a difference. The controller 424 is utilized for providing and for adjusting the gain value GM according to the calculated difference. The gain-adjusting module 426 adjusts the magnitude of the detecting signals A, B, C, and D according to the gain value GM. Please note that the gain value GM is not a fixed value. Determining the proper gain value GM is detailed as follows.

In this embodiment, the signal level generator 430 firstly performs a low-pass filter function to the adjusted detecting signals A′, B′, C′, and D′ respectively corresponding to the four detecting signals A, B, C, and D measured by the photo detector 414 of the pick-up head 410. Secondly, the signal level generator 430 sums the adjusted detecting signals A′, B′, C′, and D′ to generate the signal level L. That is, the signal level L represents an average of the total magnitude of these adjusted detecting signals A′, B′, C′, and D′. The comparing module 422 receives the signal level L (i.e., A′+B′+C′+D′) from the signal level generator 430 and compares the signal level L with the reference target level L_{ref} to determine a difference between the signal level L and the reference target level L_{ref}. The controller 424 tunes the gain value GM according to the difference provided by the comparing module 422. If the signal level L is greater than the reference target level L_{ref}, the controller 424 will reduce the gain value GM and send the updated gain value GM to the gain-adjusting module 426 to lower the magnitude of the detecting signals A, B, C, and D. Alternatively, if the signal level L is less than the reference target level L_{ref}, the controller 424 will increase the gain value GM and send the updated gain value GM to the gain-adjusting module 426 to heighten the magnitude of the detecting signals A, B, C, D.

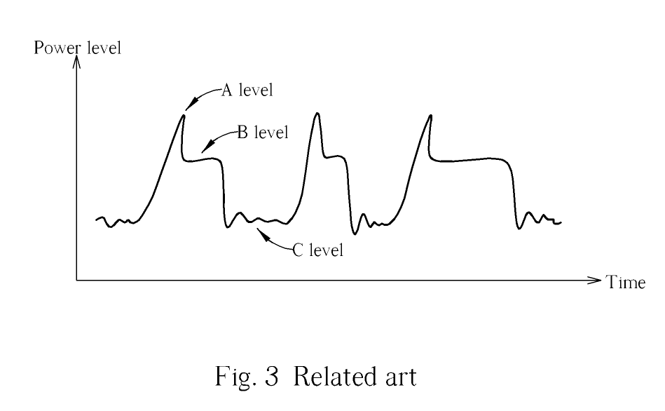

Please note that determining the signal level L is not limited to summing the adjusted detecting signals A′, B′, C′, and D′. As shown in FIG. 3, the B level is the major component of a detecting signal. Therefore, in another embodiment, the signal level generator 430 can sum B levels of these adjusted detecting signals A′, B′, C′, and D′ to determine the signal level L. In practice, the servo system 400 can include a sample/hold circuit (not shown) to collect the B level of each detecting signal. In the preceding description, all of the adjusted detecting signals A′, B′, C′, and D′ are utilized to determine the signal level L. However, it is also sufficient to utilize any combination of these signals A′, B′, C′, and D′ to determine the signal level L. For example, one of the adjusted detecting signals A′, B′, C′, or D′ is utilized to set the signal level L. That is, the signal level L is set by the average magnitude or the B level of one adjusted detecting signal. The same objective of tuning the gain value GM is achieved.

Please note that for each signal level-determining scheme there is a proper reference target level L_{ref} that should be utilized. In a preferred embodiment of the present invention, the comparing module 422 can accept a plurality of different reference target levels. Once accepted, the comparing module 422 can select one of these candidate reference target levels according to the current signal level-determining scheme. For instance, the comparing module 422 includes a multiplexer for selecting one reference target level from the many candidate reference target levels that are available.

After the detecting signals outputted from the photo detector 414 are properly adjusted, the desired tracking error signal TE and focusing error signal FE can be correctly obtained. Taking the tracking error signal TE for example, it is yielded from a main beam push-pull signal M_{b} minus the result of a fixed parameter Kₛ multiplied by a side beam push-pull signal S_{b} (TE=M_{b}−(Kₛ*S_{b})). In this way, the servo signal can be properly normalized by separately tuning the main beam push-pull signal and the side beam push-pull signal. In summary, the servo system 400 is stabilized during the data recording process due to the gain stage 420, which adjusts the detecting signals before the corresponding servo signals are generated.

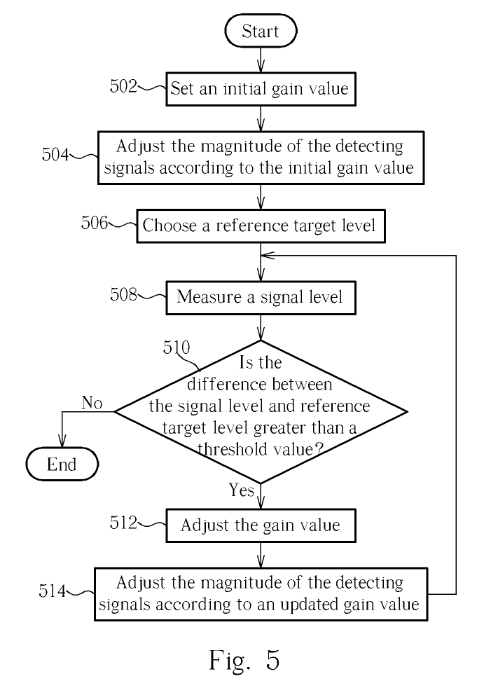

Please refer to FIG. 5 in conjunction with FIG. 4. FIG. 5 shows a flowchart illustrating the detailed operation of tuning the gain value GM set to the gain-adjusting module 426 shown in FIG. 4. The steps of the flowchart need not be in the exact order shown in FIG. 5 if the result achieved is substantially the same. The flowchart contains following steps:

Step 502: The controller 424 sets an initial gain value GM to the gain-adjusting module 426.

Step 504: The gain-adjusting module 426 adjusts the magnitude of the incoming detecting signals A, B, C, and D according to the initial gain value GM.

Step 506: The comparing module 422 selects a reference target level L_{ref}.

Step 508: The signal level generator 430 measures a signal level L according to the output of the gain-adjusting module 426.

Step 510: The comparing module 422 compares the signal level L with the reference target level L_{ref} and determines a difference between the signal level L and the reference target level L_{ref} with a threshold value. If the difference is greater than the threshold value, go to step 512; otherwise, end this process.

Step 512: The controller 424 adjusts the gain value GM according to the comparing result outputted from the comparing module 422.

Step 514: The gain-adjusting module 426 adjusts the magnitude of the incoming detecting signals A, B, C, and D according to an updated gain value GM; go to step 508.

Please note that the initial gain value can be set utilizing a variety of means. For example, a look-up table can be utilized that is pre-built and stored in the controller 424. The look-up table records a plurality of initial gain values mapped to a plurality of driving voltages of the laser diode 412. In general, when a selected driving voltage causes the laser diode 412 emit a higher write power, then a less value should be set to the initial gain value. This is necessary to properly reduce the magnitude of the detecting signals A, B, C, and D. Therefore, referencing the look-up table provides an initial gain value corresponding to a driving voltage of the laser diode 412. This is an easy means for determining the initial gain value. According to the flowchart, if the current gain value GM is unable to properly reduce the magnitude of the detecting signals A, B, C, and D, then the signal level L would be greater or less than the reference target level L_{ref}. Therefore, the controller 424 determines how to tune the gain value GM according to the level difference detected by the comparing module 422, and then updates the current gain value GM. However, if the current gain value GM is capable of properly reducing or increasing the magnitude of the detecting signals A, B, C, and D, the signal level L would be equal to the reference target level L_{ref}. Therefore, the controller 424 keeps the current gain value GM unchanged. As mentioned above, it is obvious that the gain stage 420 operates in response to an increase or decrease of the write power. Therefore, the gain value GM is adjusted when the signal level L is too high/low because of the boosted write power applied to the optical disc 401.

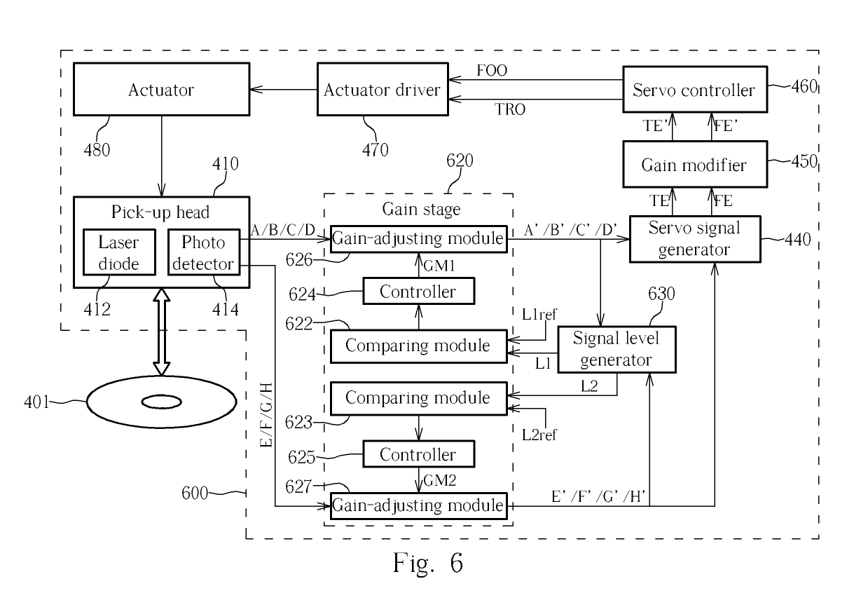

In addition, the above-mentioned detecting signals A, B, C, and D correspond to the reflected main beam. So, the gain stage 420 is utilized to tune the reflected main beam signals by setting a proper gain value GM. However, the gain stage 420 is not limited to only adjusting the reflected main beam signals. That is, the detecting signals corresponds to the reflected side beam can also be adjusted by the gain stage 420 as well. Please refer to FIG. 6. FIG. 6 shows a block diagram of a servo system 600 in an optical disc drive (e.g., a DVD drive) according to a second embodiment of the present invention. Since the elements of the same name in the first and second embodiment have the same function and operation, a detailed description is omitted for the sake of brevity. The key difference between the first and second embodiment is that the gain stage 620 is capable of tuning the reflected main beam signals and side beam signals simultaneously and respectively by setting different gain values GM1 and GM2 according to the main beam signals and side beam signals. The signal level-determining scheme applied to the reflected side beam signals in FIG. 6 is similar to the signal level-determining scheme that is applied to the reflected main beam signals in FIG. 4. The photo detector 414 outputs two types of detecting signals, one type is detecting signals A, B, C, and D corresponding to the reflected main beam, and the other type is detecting signals E, F, G, and H corresponding to the reflected side beam. Therefore the signal level generators 630 performs a low-pass filter function to the adjusted detecting signals A′, B′, C′, and D′ which are corresponding to the four detecting signals A, B, C, and D and the adjusted detecting signals E′, F′, G′, and H′ which are corresponding to the four detecting signals E, F, G, and H.

Next, the signal level generator 630 generates the signal level L1 according to these adjusted detecting signals A′, B′, C′, and D′, and generates the signal level L2 according to these adjusted detecting signals E′, F′, G′, and H′. The comparing modules 622 and 623 receive the signal level L1 and L2 respectively from the signal level generator 630 and compare the signal level L1 and L2 with the reference target level L1_{ref} and L2_{ref}. The comparing module 622 determines a difference according to a comparison of the signal level L1 and the reference target level L1_{ref} and the comparing module 623 determines another difference according to a comparison of the signal level L2 and the reference target level L2_{ref}. The controller 624 tunes the gain value GM1 according to the difference provided by the comparing module 622, and similarly, the controller 625 tunes the gain value GM2 according to the difference provided by the comparing module 622. Then the gain-adjusting module 626 adjusts the magnitude of the detecting signals A, B, C, and D according to the gain value GM1 and the gain-adjusting module 627 adjusts the magnitude of the detecting signals E, F, G, and H according to the gain value GM2 in accordance with the adjusting operation of tuning the gain value GM as mentioned before. That is, the operation of tuning the gain values GM1 and GM2 respectively set to the gain-adjusting modules 626 and 627 are the same as the operation of tuning the gain value GM set to the gain-adjusting module 426 shown in FIG. 5.

Please note that, in this embodiment the signal level L1 is generated according to the reflected main beam signals (i.e., the adjusted detecting signals A′, B′, C′, and D′) and the signal level L2 is generated according the reflected side beam signals (i.e., the adjusted detecting signals E′, F′, G′, and H′). That is, the gain stage 620 adjusts the magnitudes of the reflected main beam signals and reflected side beam signals independently according to their own detecting signals. However, in other embodiments, the signal levels L1 and L2 can be determined by the same detecting signals source (i.e., either the adjusted detecting signals A′, B′, C′, and D′ or the adjusted detecting signals E′, F′, G′, and H′). That is, the signal level generator 530 can generate the signal level L1 and L2 only according to the reflected main beam signals, or only according to the reflected side beam signals. In this result, the values of the signal levels L1 and L2 are identical, and the values of the reference target levels L1_{ref} and L2_{ref} are also identical. The gain stage 520 can adjust the magnitudes of both the reflected main beam signals and reflected side beam signals simultaneously by selecting one detecting signals source (i.e., either the adjusted detecting signals A′, B′, C′, and D′ or the adjusted detecting signals E′, F′, G′, and H′).

In contrast to the related art servo control mechanism, the servo system of the present invention provides improved stability. Prior to generating the servo signals, composed of the tracking error signal and the focusing error signal, the servo system utilizes a gain stage to properly reduce the magnitude of detecting signals generated by a photo detector of a pick-up head, thereby minimizing the influence of the write power. Further, the servo system of the present invention respectively adjusts the magnitude of the reflected main beam signals and reflected side beam signals. Once the magnitude adjustments are completed, the servo system of the present invention is capable of preventing the servo signals from fluctuating heavily. The servo system of the present invention is capable of immediately updating the gain value in response to the write power adjustment during the data recording process. Compared with the related art servo system that utilizes the sample/hold scheme, the present invention servo system is applicable to high-speed data recording.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A servo system of an optical storage device, the servo system comprising:
a pick-up head for detecting signals reflected from an optical disc to generate a plurality of detecting signals;
a gain stage coupled to the pick-up head for determining a gain value according to an output level of the pick-up head and for adjusting the magnitude of the detecting signals according to the gain value; and
a servo signal generator coupled to the gain stage for generating the servo signal according to the adjusted detecting signals outputted from the gain stage.

2. The servo system of claim 1 wherein the gain stage comprises:
a comparing module for comparing a signal level corresponding to an output of the pick-up head with a reference target level , and determine a signal difference between the signal level and the reference target level;
a controller coupled to the comparing module for adjusting the gain value according to the signal difference; and
a gain-adjusting module coupled to the controller for adjusting the magnitude of the detecting signals according to the gain value.

3. The servo system of claim 2 wherein the output of the pick-up head includes the detecting signals.

4. The servo system of claim 3 further comprising:
a signal level generator coupled between the gain-adjusting module and the comparing module for determining the signal level according to at least a detecting signal processed by the gain-adjusting module.

5. The servo system of claim 4 wherein the signal level generator determines the signal level by summing the detecting signals processed by the gain-adjusting module.

6. The servo system of claim 1 wherein the detecting signals are main beam signals and/or side beam signals.

7. The servo system of claim 1 wherein the pick-up head operates under a write mode.

8. A method for generating a servo signal of an optical storage device, the method comprising:
detecting signals reflected from an optical disc to generate a plurality of detecting signals by a pick-up head;
determining a gain value according to an output level of the pick-up head;
adjusting the magnitude of the detecting signals according to the gain value; and
generating the servo signal according to the detecting signals adjusted by the gain value.

9. The method of claim 8 wherein the step of determining the gain value further comprises:
comparing a signal level corresponding to the output of the pick-up head with a reference target level ,and determine a difference between the signal level and the reference target level; and
adjusting the gain value according to the difference.

10. The method of claim 9 wherein the output of the pick-up head includes the detecting signals.

11. The method of claim 10 the step of determining the gain value further comprises:
determining the signal level according to at least a detecting signal processed by the gain value.

12. The method of claim 11 the step of determining the gain value further comprises:
summing the detecting signals processed by the gain value to determine the signal level.

13. The method of claim 8 wherein the detecting signals are main beam signals and/or side beam signals.

14. The method of claim 8 wherein the pick-up head operates under a write mode.

15. A servo system of an optical disc drive for generating a servo signal, the servo system comprising:
a pick-up head for detecting signals reflected from an optical disc to generate a plurality of first detecting signals and a plurality of second detecting signals;
a gain stage coupled to the pick-up head for determining a first gain value according to an output of the pick-up head and for adjusting the magnitude of the first detecting signals according to the first gain value, and determining a second gain value according to the output of the pick-up head and for adjusting the magnitude of the second detecting signals according to the second gain value; and
a servo signal generator coupled to the gain stage for generating the servo signal according to the first and second adjusted detecting signals outputted from the gain stage.

16. The servo system of claim 15 wherein the gain stage comprises:
a first comparing module for comparing a first signal level corresponding to the first detecting signals with a first reference target level, and determining a first difference between the first signal level and the first reference target level;
a second comparing module for comparing a second signal level corresponding to the second detecting signals with a second reference target level, and determining a second difference between the second signal level and the second reference target level;
a first controller coupled to the first comparing module for adjusting the first gain value according to the first difference;
a second controller coupled to the second comparing module for adjusting the second gain value according to the second difference;
a first gain-adjusting module coupled to the first controller for adjusting the magnitude of the first detecting signals according to the first gain value; and
a second gain-adjusting module coupled to the second controller for adjusting the magnitude of the second detecting signals according to the second gain value.

17. The servo system of claim 15 wherein the output of the pick-up head includes the first or second detecting signals.

18. The servo system of claim 17 further comprising:
a signal level generator coupled to and disposed between the first and second gain-adjusting modules and the first and second comparing modules for determining the first signal level according to at least a detecting signal processed by the first gain-adjusting module and determining the second signal level according to at least a detecting signal processed by the second gain-adjusting module.

19. The servo system of claim 18 wherein the signal level generator determines the first signal level by summing the first detecting signals processed by the first gain-adjusting module and determines the second signal level by summing the second detecting signals processed by the second gain-adjusting module.

20. The servo system of claim 15 wherein the first detecting signals are main beam signals and the second detecting signals are side beam signals.

21. The servo system of claim 15 wherein the pick-up head operates under a write mode.

22. A method for generating a servo signal of an optical storage device, the method comprising:
providing a pick-up head and utilizing the pick-up head for detecting signals reflected from an optical disc to generate a plurality of first detecting signals and a plurality of second detecting signals;
determining a first gain value according to an output of the pick-up head;
determining a second gain value according to the output of the pick-up head;
adjusting the magnitude of the first detecting signals according to the first gain value;
adjusting the magnitude of the second detecting signals according to the second gain value; and
generating the servo signal according to the first and second detecting signals adjusted by the first and second gain values.

23. The method of claim 22 wherein the step of determining the gain value further comprises:
comparing a first signal level corresponding to the first detecting signals and a first reference target level, and determining a first difference between the first signal level and the first reference target level;
comparing a second signal level corresponding to the second detecting signals and a second reference target level, and determining a second difference between the second signal level and the second reference target level;
adjusting the first gain value according to the first difference; and
adjusting the second gain value according to the second difference.

24. The method of claim 22 wherein the output of the pick-up head includes the first or second detecting signals.

25. The method of claim 22 the step of determining the first gain value further comprises:
determining the first signal level according to at least a detecting signal processed by the first gain value; and
the step of determining the second gain value further comprises:
determining the second signal level according to at least a detecting signal processed by the second gain value.

26. The method of claim 22 the step of determining the first gain value further comprises:
summing the first detecting signals processed by the first gain value to determine the first signal level; and
the step of determining the second gain value further comprises:
summing the second detecting signals processed by the second gain value to determine the second signal level.

27. The method of claim 23 wherein the first detecting signals are main beam signals and the second detecting signals are side beam signals.

28. The method of claim 23 wherein the pick-up head operates under a write mode.
